(19) United States
(12) Patent Application Publication
(10) Pub. No.: US 2014/0337137 A1
(43) Pub. Date: Nov. 13, 2014

(54) Digital Billboard Advertising

(71) Applicant: Fliphound LLC, Wichita, KS (US)

(72) Inventors: Douglas M. Robertson, Chatham, NJ (US); Brandon Shuey, Wichita, KS (US)

(73) Assignee: Fliphound LLC, Wichita, KS (US)

(21) Appl. No.: 14/268,658

(22) Filed: May 2, 2014

Related U.S. Application Data
(60) Provisional application No. 61/820,631, filed on May 7, 2013.

(51) Int. Cl. G06Q 30/02

(52) U.S. Cl. CPC G06Q 30/0264; G06Q 30/0273
USPC 705/14.61

(57) ABSTRACT

An advertising campaign is provided for display on one or more digital billboards. Information about a geographic location of the digital billboard and an available inventory of time intervals for display of digital content is established. Pricing guidelines for the available inventory are defined, and digital content campaigns are created that identify a particular digital billboard or billboards, and specify pricing information indicating prices for displaying digital content on the billboard. A contract is executed for the digital content campaign, and the digital content associated with the campaign is displayed on the digital billboard based on a play schedule defining a time interval and number of times that the digital content will be displayed for the time interval.

### CROSS REFERENCE TO RELATED APPLICATIONS

This application claims the benefit of U.S. Provisional Application No. 61/820,631, filed May 7, 2013, which is hereby incorporated by reference herein.

### BACKGROUND

The billboard marketplace has developed a great deal with the introduction of digital billboards, which can include any sign with a digital display located either outdoors (off premise) or indoors (on premise). Digital billboards and other similar displays allow one physical billboard space to present multiple pieces of digital content (including digital messages) over a period of time, by “flipping” (or rotating) between various pieces of digital content. Digital billboards provide significant advantages over traditional static billboards, since digital displays are linked to computer systems that can instantaneously and simultaneously change the digital content on a large number of digital billboard displays. Furthermore, each digital billboard can accommodate advertisements from multiple advertisers.

While static billboards still compose the majority of outdoor billboards, billboard operators are seeing increased revenues when they upgrade to digital billboards. Other parties may also increase revenues by implementing digital billboards. For example, retail stores, the hospitality industry, schools, the transportation industry, corporations, sporting venues, theaters, and other in-building networks (such as elevators) may all use digital billboards. However, current methods of selling digital billboard space are cumbersome and require a large amount of legwork from advertisers, digital billboard operators, and related third parties including media buyers, advertising agencies, and web designers. Such legwork includes linking advertisers with digital billboard operators, finding desirable billboard locations, negotiating prices, and generating digital content to be displayed on the billboards. Furthermore, on average, 25-35% of the flips on digital billboards remain unsold. This unsold inventory represents a large amount of revenue not realized by digital billboard operators.

### SUMMARY

Described herein are methods and systems for providing an advertising campaign on a digital billboard. In an embodiment, information is established about at least one digital billboard operated by a seller, the established information including a geographic location of the digital billboard and an available inventory formed of time intervals in which digital content may be displayed by the digital billboard. Pricing guidelines are established for the seller, indicating pricing requirements for the available inventory. Multiple digital content campaigns are received from advertisers, the digital content campaigns identifying the digital billboard operated by the seller and specifying pricing information indicating prices advertisers will pay to display digital content on the billboard. Then, a digital content campaign is selected responsive to an analysis of the digital content campaigns and the pricing guidelines. A play schedule is created for the selected digital content campaign that defines a time interval and a number of times that the digital content will be displayed, and instructions are sent to the digital billboard for displaying the digital content.

In some embodiments, a frequency is selected for displaying digital content on the billboard, and the play schedule is created based on the selected frequency. In other embodiments, pricing guidelines are defined based on a fixed frequency for displaying digital content on the digital billboard, and the play schedule is created based on the fixed frequency. In certain other embodiments, the pricing requirements include a fixed price, and the pricing information is specified based on the fixed price. In some embodiments, the pricing requirements include a bidding scheme specifying a budget and time frame, and the pricing information is specified based on the bidding scheme. In certain other embodiments, the information about the billboard includes information about traffic conditions near the billboard, proximity of the billboard to a specific business, and proximity of the billboard to a selected geographic region. In some embodiments, the digital content campaign includes instructions to display digital content on specified days of a week or specified times during a day, and the play schedule is created based on these instructions.

In some embodiments, a second digital content campaign is selected from the multiple digital content campaigns, and a play schedule is created for the second campaign, the play schedule being distinct from the play schedule for the first selected digital content campaign. Instructions are then provided to the digital billboard for displaying the digital content for the second campaign, and the digital billboard is configured to combine the play schedules created for the two digital campaigns. In other embodiments, digital content is modified by changing a graphic element of the digital content, and the modified digital content is included in the digital content campaign. In certain other embodiments, digital content associated with the digital content is assessed to confirm whether the digital content fulfills content restrictions. If the digital content does not fulfill the content restrictions, the campaign is rejected. In other embodiments, the digital content is formatted to allow the digital content to be displayed according to dimensions of the digital billboard. In certain other embodiments, the instructions provided to the digital billboard include a file containing the digital content associated with the digital content campaign, and the file includes executable code.

### BRIEF DESCRIPTION OF THE DRAWINGS

FIG. 1 is a high-level block diagram illustrating an environment including an advertising platform, in accordance with an embodiment of the invention.

FIG. 2 is a high-level block diagram illustrating a detailed view of various modules within the advertising platform, in accordance with an embodiment of the invention.

FIG. 3 is a flowchart illustrating steps performed by the advertising platform to manage billboard advertising, according to one embodiment.

FIG. 4 is a high-level block diagram illustrating an example of a computer, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures and may indicate similar or like functionality.

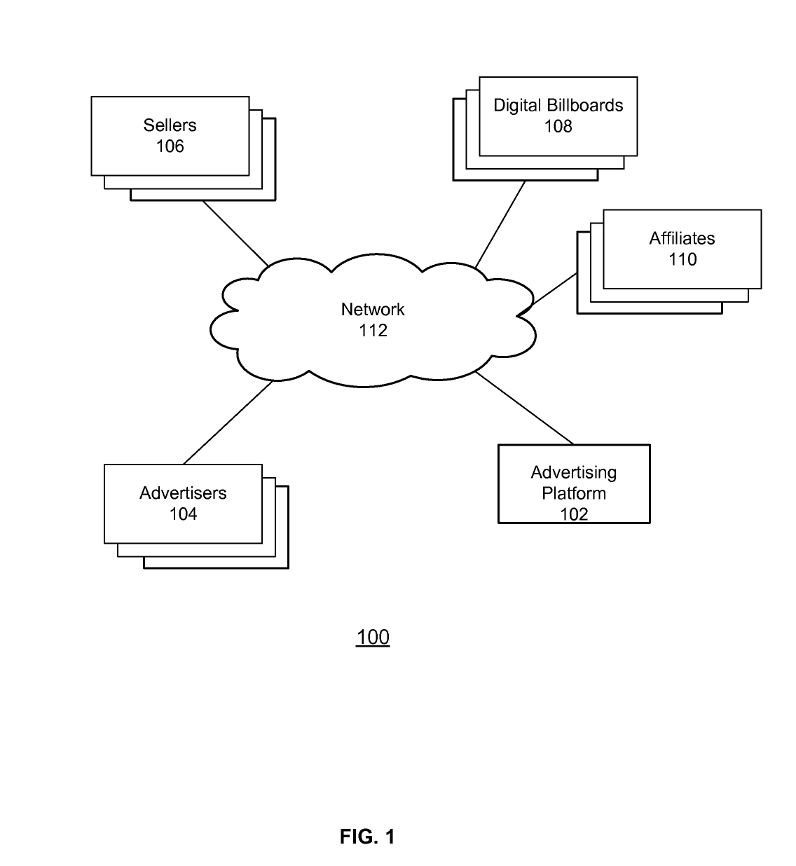

FIG. 1 is a high-level block diagram illustrating an environment 100 including an advertising platform 102 according to one embodiment. A network 112 connects the advertising platform 102 to multiple advertisers 104, multiple sellers 106, multiple affiliates 110, and multiple billboards 108. Only three examples are shown for each of the advertisers 104, sellers 106, affiliates 110, and billboards 108 (represented by the stacked rectangles). However, there can be thousands or millions of each entity in some embodiments. Moreover, the environment 100 may also include multiple networks 112 and advertising platforms 102. As used herein, the term “billboard” refers to a digital billboard unless otherwise specified.

The advertising platform 102 is provided by one or more computing devices and allows advertisers 104 and sellers 106 to locate, list, buy, sell, generate, manage, and pay for digital content to be displayed on billboards 108. For example, the advertising platform 102 provides capabilities for creating and executing physical and paperless contracts for digital content, managing and reviewing digital content, managing accounts and payments, and displaying digital content on billboards 108. The workflow processes of the advertising platform 102 may also be used to facilitate the execution of a contract regarding the display of static content on a billboard (e.g., a non-digital billboard). Manual intervention may be required to create and display this static content.

The advertisers 104 are entities that use computing devices to interact with the advertising platform 102 and submit the information necessary to generate and execute a contract and manage campaigns. A computing device may be, for example, a desktop, notebook, or tablet computer, a mobile telephone, a video game system, a television set top box (STB), or other electronic device. An advertiser 104 (including an agent of the advertiser, a media buyer, or other individual) generally wishes to publicly display digital content on billboards 108, including video, text, images, or other content. The advertiser 104 interacts with the advertising platform 102 to form contracts with sellers 106 to purchase billboard 108 space, and to create, prepare and upload digital content for display on billboards 108.

The sellers 106 are also entities that use computing devices to interact with the advertising platform 102. A seller 106 is generally the owner (including an agent of the owner) of one or more digital and/or static billboards 108. To sell billboard 108 space, the seller submits information regarding the one or more billboards 108 to the advertising platform 102. The seller 106 interacts with the advertising platform 102 to form contracts with advertisers 104 to sell billboard 108 space, and to manage digital content for display on billboards 108.

The affiliates 110 are entities that use computing devices to interact with the advertising platform 102. An affiliate 110 is an entity that may display a web component of the advertising platform 102 on the affiliate's website. An advertiser 104 may interact with the advertising platform 102 via the web component of an affiliate 110. The web component thus allows advertisers 104 and sellers 106 to access the functionality of the advertising platform 102 through affiliate websites or other applications, without directly accessing the advertising platform.

The billboards 108 display digital content provided by the advertising platform 102. Billboards 108 are digital displays located at various fixed or mobile physical locations, and are configured to display particular digital content at specific times depending on instructions received from the advertising platform 102. The billboards 108 may be special purpose devices or integrated into other general purpose devices. Billboards 108 are generally configured to show multiple pieces of digital content, by “flipping” among different pieces of digital content, where “flipping” generally means to rotate or switch between displaying different digital content. Billboards 108 will display a piece of digital content for a certain time interval (i.e., period of time called a “flip”) before flipping to the next piece of digital content that replaces the previously-displayed content. In one embodiment, a piece of digital content is displayed for an eight second interval before flipping to a new piece of digital content. In other embodiments, the digital content is shown for different intervals, such as five seconds or ten seconds. In some embodiments, the billboards 108 are static and display fixed content until the content is manually changed upon instruction from the advertising platform 102.

The network 112 facilitates communications between the advertising platform 102, the advertisers 104, the sellers 106, and the billboards 108. In an embodiment, the network 112 uses standard communications technologies and/or protocols. For example, the network 112 can include links using technologies such as Ethernet, 3G, worldwide interoperability for microwave access (WiMAX), and digital subscriber line (DSL), etc. Networking protocols used on the network 112 can include, for example, multiprotocol label switching (MPLS), the transmission control protocol/Internet protocol (TCP/IP), the hypertext transport protocol (HTP), or the file transfer protocol (FTP), etc. The data exchanged over the network 112 can be represented using technologies and/or formats including the hypertext markup language (HTML), JavaScript Object Notation (JSON), or the extensible markup language (XML), etc. Some or all of the links can be encrypted by conventional encryption technologies such as secure sockets layer (SSL) or virtual private networks (VPNs), etc. In some embodiments, the advertising platform 102, advertisers 104, sellers 106, affiliates 110, and billboards 108 can use custom and/or dedicated data communications technologies instead of, or in addition to, the ones described above. In some embodiments, the network facilitates communications via a social media network.

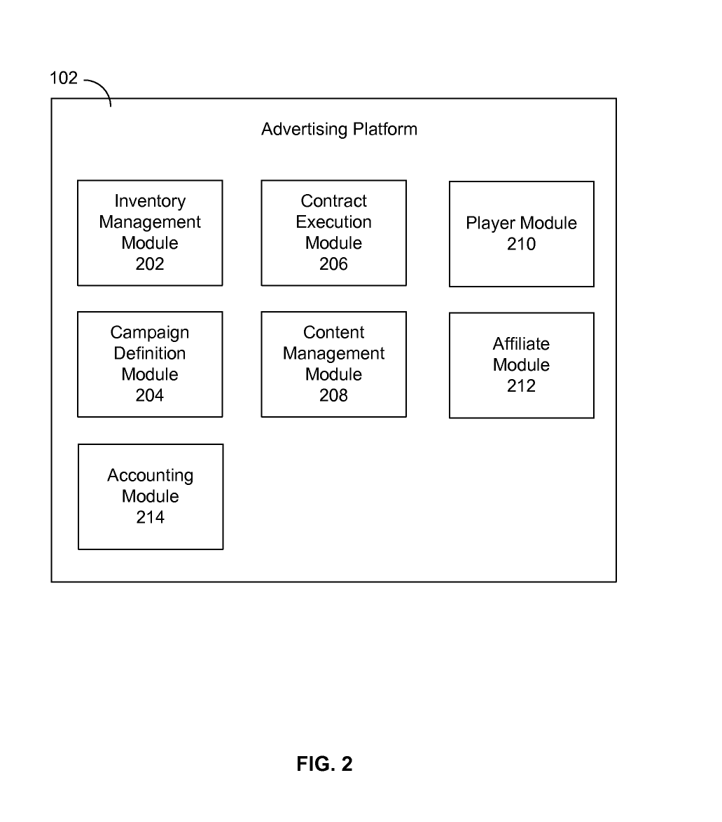

FIG. 2 is a high-level block diagram illustrating a detailed view of various modules within the advertising platform 102 according to one embodiment. As used herein, the term “module” refers to computer program logic used to provide a specified functionality. As illustrated, the advertising platform includes an inventory management module 202, a campaign definition module 204, a contract execution module 206, a content management module 208, a player module 210, affiliate module 212, and accounting module 214. Some embodiments of the advertising platform have different and/or other modules than the ones described herein. Similarly, the functions can be distributed among the modules in accordance with other embodiments in a different manner than is described here.

The inventory management module 202 allows billboard owners, or sellers 106, to provide demographic and location information, and to identify terms and policies, for their inventory of one or more digital and/or static billboards 108 and available flips (i.e., time intervals in which content may be displayed on the billboards). In one embodiment, a seller 106 submits attributes describing the inventory of billboards. The attributes for billboard 108 may include physical characteristics of the billboard or the physical environment proximate to the billboard, such as the height and width of the billboard 108, the proximity of the billboard 108 to other businesses, the amount of daily traffic that passes by the billboard 108, general traffic conditions near the billboard 108, weather patterns or weather conditions near the billboard 108, information regarding power outages, manufacturer information regarding the billboard 108, TAB ratings or other industry ratings, related player software and versions supported by the billboard, and the geographic location of the billboard 108. The location of the billboard 108 may be pinpointed on a map displayed on a user interface presented by the advertising platform 102. In some embodiments, the location of the billboard 108, the proximity of the billboard 108 to other businesses, or the proximity of the billboard 108 to a selected geographic region may be automatically mapped by the advertising platform 102 based on other attributes provided by the sellers 106.

The sellers 106 may also submit attributes describing the inventory of available flips on the billboard. This information may describe, for example, the amount of flips available, the duration of the time interval constituting a flip, the time of day, days of the week, or calendar dates on which the flips are available.

The seller 106 may also use the inventory management module 202 to define a content policy specifying characteristics of digital content that may be displayed on the seller's billboards. The content policy may specify restrictions regarding the types of digital content that cannot be displayed on a seller's 106 billboard 108. For example, the content policy may specify that a billboard 108 can or cannot display content regarding politics, religion, alcohol, drugs, sex, obscene language, etc. Furthermore, the content policy may specify that content must be excluded if it advertises a particular category of goods or services, such as fast food, car sales, or medicine/hospitals. The seller 106 may also specify time/date restrictions for the content policies, such that different content policies are in effect for the same billboard at different dates or times.

The inventory management module 202 also allows a seller 106 to set pricing guidelines, or requirements, for an advertiser 104 who wishes to pay to display digital content on the seller's 106 billboard. The seller 106 can set a base price, a minimum bid, or a set price (“buy it now” price). The seller 106 can also determine price discounts or price increases based on multiple factors, including time, frequency of display, time of day of display, display schedule, and value of advertising time.

In some embodiments, the seller 106 sets pricing guidelines based on frequency and timing of the display of digital content. For example, the seller 106 can provide prices for individual flips in which digital content is displayed on the billboard 108. These time intervals can be of equal or varying lengths of time, with different prices specified for different-length flips. In some embodiments, the pricing guidelines include prices for an absolute number of flips of a specified duration. Furthermore, the seller 106 can determine whether an advertiser 104 must pay per flip, per day (or other length of time), some combination of both, or a separate flat fee.

In one embodiment, a seller 106 with unsold inventory of billboard flips can provide a discounted price or discounted minimum bid in an attempt to sell more billboard 108 space. In another embodiment, the seller 106 or advertising platform 102 may provide package prices for display on a pre-determined set of multiple billboards, and in some cases the package prices cost less than it would to buy the same billboard space individually. The specified set of multiple billboards may be based on attributes of the billboards. The seller 106 or advertising platform 102 may package billboards together such that the billboards in one package are not in close geographic proximity. In some cases, the seller 106 or advertising platform 102 can identify and/or group the most valuable and least valuable billboards in a region, and set pricing for specific billboards accordingly.

The inventory management module 202 further allows sellers 106 to schedule inventory that has been sold or is committed to be sold, make flips (instances) available on a billboard display, collect and post inventory-related notes, follow up on various tasks related to inventory, and organize digital content leads by seasonality, category, and inventory purchase size.

The campaign definition module 204 allows advertisers 104, i.e. buyers, to review the terms and policies set by sellers 106 regarding the billboards 108, and to specify digital content campaigns for the advertisers' preferred billboards 108. This includes generating contracts, bids, budgets, and other specifics of displaying an advertiser's 104 digital content on a billboard 108. In some embodiments, advertisers access elements of the campaign definition module 204 using social media services. An advertiser 104 can use the campaign definition module 204 to define a campaign policy to generate a campaign. The campaign policy specifies various terms regarding the campaign, including digital content pricing, timing, frequency of display, and the location and number of billboards 108 on which to display digital content. In one example, the campaign policy can define the terms of the advertiser's 104 campaign budget, and specify the maximum price the advertiser 104 is willing to pay for the digital content display. The campaign policy may use metadata associated with each billboard to filter and specify the campaign terms. An advertiser 104 may view relevant metadata in a table within the campaign definition module 204. In one embodiment, the campaign policy can specify how to filter billboards 108 or other aspects of the campaign using logic such as Boolean logic, conditional logic, and comparisons logic.

In one embodiment, an advertiser 104 defines a campaign policy by first selecting one or more billboards 108 in various locations and/or having various attributes to display the advertiser's 104 digital content. The advertiser 104 may view and select available billboards on a map that contains embedded metadata. For example, the advertiser 104 may select two billboards 108 located on different highways from a map depicting Wichita, Kans. If the advertiser 104 is selecting a package of multiple billboards, the advertiser 104 has an opportunity to select additional billboards or remove undesirable billboards from the package. In one embodiment, the advertiser 104 may add or remove billboards, as long as the package contains at least a specified minimum number of billboards having certain attributes, such as “most valuable” and “least valuable” billboards 108 as designated by the seller 106 or advertising platform 102. In a further embodiment, the minimum number of billboards can vary depending on the geographic locations of the billboards 108. Next, the advertiser 104 may select the time frame or display schedule for the campaign. For example, the advertiser 104 may specify that the campaign should last for two months. The advertiser 104 may also specify that the campaign's digital content should be displayed a certain number of instances in a day (a specified frequency), displayed for a particular time interval per instance, displayed during specified hours in a day, displayed during specified days of a week, or displayed on a certain number of selected billboards 108. For example, an advertiser 104 may specify that the campaign's digital content should be displayed between the hours of 8:00 am to 8:00 pm on weekdays.

Subsequently, the advertiser 104 chooses a budget for the campaign. In some cases, the seller 106 has already indicated a fixed price, frequency, and/or time frame for the display of digital content on the selected billboard or billboards 108. For example, the price may include the sum of the fixed prices of all of the selected billboards 108, based on the frequency and duration of the campaign. Alternatively, a discounted price may be presented based on the number of selected billboards 108, the value of the selected billboards 108 as defined by the seller 106 or the advertising platform 102, or other factors. In one example, selecting a higher number of less valuable billboards 108 will increase the discount, whereas selecting a higher number of more valuable billboards 108 will decrease the discount. In other cases, the advertiser 104 can make a bid specifying the budget and time frame for the digital content display. For example, the advertiser 104 may select and bid on a maximum total budget, or a budget per day, per flip (per instance), per message, per time interval, or per fraction of a time interval. In other embodiments, the seller 106 may bid for one or more advertisers 104. For example, the advertiser 104 may provide a standing bid and a seller 106 can accept the bid based on availability of inventory. In a further embodiment, a seller 106 may hold a flash sale to make inventory available to advertisers 104 at a reduced price.

When the price of a billboard 108 is determined by bidding (not a fixed price), an advertiser 104 may “lose” a campaign on a particular billboard 108 if another advertiser 104 has made a higher bid for the campaign. In this case, the losing advertiser 104 may be notified, and may be given a chance to submit an even higher bid. The notification may occur by email, mobile phone, or another electronic means. In some cases, the campaign definition module 204 calculates the specific price necessary to outbid a current winning bid for a campaign. Furthermore, real-time feedback may be provided regarding an advertiser's 104 bid, so that the advertiser 104 may immediately determine whether a placed bid was a winning or losing bid. In one embodiment, even if the advertiser 104 has placed a winning bid, the advertiser 104 may receive real-time feedback explaining the advertiser 104 has been outbid by another advertiser 104, or that the advertiser's 104 account associated with the advertising platform 102 does not have enough money to pay for the bid, or that the spending limit for the selected billboard 108 has already been met or exceeded. In these cases, the advertiser 104 will not win the bid.

In one embodiment, an advertiser 104 may be notified of alternative advertising packages specified by the campaign definition module 204 to be customized to the advertiser's 104 preferences. In a further embodiment, the campaign definition module 204 may use information regarding an advertiser's 104 bidding preferences, billboard selection, geographic region selected to display digital content, and current prices of relevant billboards to suggest alternative billboard selections and packages to the advertiser 104. In one embodiment, a suggestion may be sent to an advertiser 104 to enter into a fixed price contract instead of bidding for billboard space 108. In another embodiment, a suggestion may be sent to an advertiser 104 to move a bid from one billboard 108 to another billboard 108 with similar characteristics that is available at a lower price. These suggestions may be accepted by the advertiser 104, in some cases only after the advertiser 104 goes through an authentication process.

After the advertiser 104 determines the specifications of a campaign, the campaign definition module 204 generates a contract based on the campaign policy, and the contract is sent to the appropriate seller 106 for review. In another embodiment, the seller 106, not the advertiser 104, can define the campaign policy including contract terms, which an advertiser 104 can then review. In another embodiment, the advertiser 104 or the seller 106 can accept the terms of the contract using a “one click acceptance,” such that the acceptance is instantaneous and immediately executes the contract. In a further embodiment, the advertiser 104 or the seller 106 can revise, accept, or deny contract terms or suggestions from any party using the instantaneous “one click acceptance” method.

The contract execution module 206 determines whether a contract was formed between an advertiser 104 and a seller 106, and, if so, subsequently carries out the contract terms by determining what digital content will be displayed on which billboards 108. After a contract has been sent to a seller 106 for review, the seller 106 can manually choose to accept, confirm, adjust, or deny the contract, or set guidelines that will automatically determine whether a contract or campaign is accepted or denied. The seller 106 may submit reasons for acceptance or denial of a contract. In one embodiment, the seller 106 may accept a contract but deny specific line items of the contract, in which case the contract is returned to the advertiser 104 who can accept or deny the new terms. In another embodiment, a contract provided by an advertiser 104 is sent to multiple sellers, and the contract execution module 206 aggregates all seller responses before returning the contract back to the advertiser 104. If the seller 106 accepts all terms of the contract, the contract is understood to be executed.

The contract execution module 206 may analyze the advertisers 104 who have submitted contracts or bids for a particular billboard 108, and automatically determine which campaigns should be selected by the sellers 106. In one embodiment, the determinations are configured to maximize profit for each billboard 108 based on available inventory, for example. In another embodiment, an advertiser 104 who has selected a fixed contract is given priority over an advertiser 104 who has submitted a bid. In some cases, inventory that is not filled by a fixed contract subsequently becomes available for a bidding advertiser. In other cases, a contract or bid submitted by an advertiser 104 is automatically rejected based on the advertiser's financial status, such as if the advertiser has an account associated with the advertising platform 102 with a negative balance. The contract execution module 206 may automatically execute contracts depending on the results of the determinations, or may present the results to the seller 106, who may then decide which contracts to accept. Furthermore, the campaign may automatically begin when a bidding submission is complete.

After a contract regarding a particular billboard 108 has been executed, a play schedule is created by the contract execution module 206 that defines how often and for how long digital content associated with the contract will be displayed on the billboard. The play schedule is based on inventory availability, bid price, and other factors. In one embodiment, the play schedule indicates a number of flips that will be displayed on a billboard and the durations of the flips (i.e., for how long the content is displayed for the flips). In other embodiments, the play schedule specifies different information. For example, the play schedule may indicate a window of time (e.g., 5-6 PM) in which the flips of particular content will occur, but not the precise times that individual flips will occur. The play schedule may likewise indicate a frequency that a flip will occur, such as a rate of one flip per minute.

The content management module 208 allows advertisers 104 to securely upload and manage digital content on the advertising platform 102 when a contract has been executed. The digital content may be uploaded to the advertising platform 102 instantly using a “one click” method by the advertiser 104. After an advertiser uploads digital content to be displayed, the content management module 208 checks the content and adds metadata describing the content, advertiser 104, etc., and provides functionality for creating and managing the digital content. The content management module 208 can examine received digital content for compliance with a specified format, and reject any content that is not in the proper format for display on the billboard 108. In an embodiment, the content management module 208 recognizes digital content not in the proper format for display, and automatically reformats the digital content into a proper format. For example, a piece of uploaded digital content can be resized to fulfill a size requirement to fit the dimensions of a particular billboard 108. In a further embodiment, the dimensions of a billboard can include size dimensions, a file type, a feed type, or any other aspect of the billboard. In one embodiment, the examination of digital content is performed automatically by the content management module 208.

After the upload, content management module 208 stores the digital content in a digital library for easy access, user provisioning, and future use. In an embodiment, the library also contains stock images for use as digital content provided by the content management module 208 or by a third party. In some embodiments, an advertiser 104 or seller 106 can “drag and drop” content for upload. If an advertiser 104 wishes to create new digital content or edit uploaded digital content, the content management module 208 provides functionality called “Ad Builder,” which allows an advertiser to generate a template-based piece of digital content. Ad Builder may edit or otherwise modify a piece of digital content uploaded by the advertiser 104 to change graphic elements of the digital content, or Ad Builder may create new digital content based on preferences selected by the advertiser 104.

If an advertiser 104 wishes to create new digital content or edit an uploaded piece of digital content, Ad Builder presents the advertiser 104 with a series of visual images or templates to select from. The advertiser 104 may also answer a series of questions provided by Ad Builder to narrow down the creative options for the digital content. For example, the advertiser 104 may specify that the purpose of the digital content is for a call to action, for branding, or to advertise an event. The advertiser 104 may also specify that the desired digital content will be related to a particular business category, or specify the style of billboard display that is most preferable. For example, the advertiser 104 may select a 50%/50% split, 70%/30% split, stacked, or centered display. In other embodiments, the advertiser 104 may select a logo, input a message, display contact information, or provide other creative advice. Some or all of the information provided to Ad Builder by the advertiser 104 is used to create new digital content or edit a piece of digital content. Also, Ad Builder may set certain guidelines to maximize the visibility of digital content. For example, Ad Builder may select ideal color schemes, font size, and word count for a particular piece of digital content.

In one embodiment, the Ad Builder-created digital content is sent to a graphic artist for further development and customization. The graphic artist may be associated with the advertising platform 102 or may be a third party. After Ad Builder and/or the graphic artist have finished generating the digital content, it is sent to the advertiser 104 for approval. In another embodiment, the advertiser 104 may request multiple pieces of digital content to be created, so that the advertiser 104 can select one to ultimately be displayed on a billboard. The digital content may undergo multiple rounds of revision depending on approval or lack thereof from the advertiser 104. Ad Builder may provide a stored history of the various revised pieces of digital content for tracking purposes. In one embodiment, the advertiser 104 can pay a fee to own the digital content.

The content management module 208 may provide the advertiser 104 with a display of the uploaded digital content that demonstrates (e.g., visually-simulates) how the display will look on specific billboard 108 to a typical viewer. For example, metadata from a billboard 108 may be used to determine the physical location of the billboard, as well as the typical viewing distance of the billboard 108 (for example, the distance from the billboard an automobile can be to effectively view the digital content display). Various geometric and algorithmic processes may be used to adjust for the angle, distance, speed of traffic, billboard manufacturer, color, and lighting conditions to show an advertiser 104 a mock display of what a piece of digital content on a particular billboard 108 will look like to a typical viewer. The billboard 108 may adjust its intensity light output depending on the displayed digital content and the time of day, and simulations of these adjustments may also be viewable by the advertiser 104.

After the advertiser 104 has approved a piece of digital content for display on a billboard 108, the seller 106 has an opportunity to review the digital content, and may set content restrictions on an individual contract basis. In one embodiment, other content reviewers associated with the advertising platform 102 can assess the digital content and add metadata to the images' records, which is used by the content management module 208 to determine if the uploaded content contains allowable content based on the restrictions specified by the seller 106. If the content contains non-allowable content, the content is rejected. A message may be sent to the advertiser 104 with reasons or suggestions regarding the rejected content, and the advertiser 104 may be permitted to revise the digital content to re-submit for approval. If the digital content is approved by the seller 106 and/or the other content reviewers, it is sent to a billboard 108 for display.

The player module 210 causes the digital content to be displayed on specified billboards 108 based on the play schedules and/or other information provided by the contract execution module 206 and the content management module 208. In an embodiment, the player module 210 sends the digital content as code and/or data files to the billboards 108 using a file transfer protocol such as HTTP, TCP, or FTP. The file may comprise code executable on the billboard 108 to produce the content. The file may be in a format such as the ADOBE FLASH format, an HTML POST format, an HTML GET format, or in an XML format.

In one embodiment, the player module 210 encapsulates the digital content (including graphics, text, images, video, live feeds, dynamic content, and/or static content) in a universal content container that it securely transfers to the proper billboard for display. This universal content container allows the digital content to be automatically played in real time or near real-time on a variety of different billboards 108. The universal content container may act as a universal player that executes on or otherwise interfaces with the different proprietary players of digital billboards 108 and displays content instantly.

In one embodiment, the universal content container includes one or more images, a schedule, and logic regarding the execution of a playlist for a billboard 108. The logic may include executable code that is executed by a computer processor of the digital billboard 108 to perform functionality for displaying the one or more images on the billboard according to the schedule. The universal content container thus allows the digital content to be compatible with a variety of different billboards 108. The billboard 108 may receive the universal content container by requesting content dynamically from the player module 210, by downloading a version of the universal content container and scheduling the container within the billboard's 108 own player, or by automatically connecting with other player software, or by automatically connecting with digital display manufacturer software. In some embodiments, the universal content container is configured to determine which billboard 108 is to play which content, and provides validation for the play by displaying a validation image on the billboard 108 for visual verification. In further embodiments, the universal content container may, when executed, request digital content or a schedule from the player module 210. In these embodiments, the universal content container might not include images or a schedule.

As mentioned above, the player module 210 receives the play schedule from the contract execution module 206. The play schedule defines how often and for how long digital content associated with the contract will be displayed on the billboard 108. The player module 210 may retrieve digital content from the digital content library and play the content as specified by the play schedule. In one embodiment, the play schedule specifies that a piece of digital content is to be displayed on multiple billboards 108, either simultaneously, or one billboard 108 at a time. If the digital content “rotates” between multiple billboards 108, the duration of the display may be the same or different for all billboards 108. In further embodiments, the play schedule may specify that the piece of digital content moves from billboard to billboard 108 in a “round robin” fashion in which the content is shown on only one billboard at a time, and moves from billboard to billboard where the duration of each display (flip) is equal to the campaign duration divided by the number of boards in the campaign, or moves from billboard to billboard where the duration of each display is not equal to the other display durations, and the duration is based on a duration priority determined by the advertiser 104 or the seller 106.

In other embodiments, the player module 210 combines multiple play schedules to create a playlist that displays multiple pieces of digital content at different times. In one embodiment, the playlist intertwines multiple play schedules, each play schedule created based on a selected frequency for displaying digital content. For example, play schedule A may be configured to display a first piece of digital content ten times at five seconds each, play schedule B may be configured to display a second piece of digital content six times at twelve seconds each. A playlist for a combination of these play schedules might have the following pattern: A (eight seconds), B (ten seconds), A (eight seconds), B (ten seconds), and so on. Alternatively, the combination playlist may use any combination of the play schedules, so that another example playlist might have the following pattern: A (eight seconds), A (eight seconds), B (ten seconds), B (ten seconds). In some embodiments, the player module 210 automatically determines one or more play schedule patterns for displaying different pieces of digital content. In other embodiments, the player module 210 is configured to automatically intertwine multiple play schedules for maximum variety, so that each piece of digital content is always displayed before and/or after a different piece of digital content.

In an embodiment, the player module 210 is configured so that a billboard 108 never displays empty space (a blank billboard) due to unsold inventory. When a billboard 108 has unsold inventory, the player module 210 can automatically create a playlist based on play schedules currently slated for the billboard 108. This may involve increasing the frequency for displaying a particular piece of digital content, or repeating one or more play schedules. In a further embodiment, the player module 210 can automatically access an inventory of filler digital content, and display the filler digital content during any unsold time intervals. The player module 210 may select filler digital content that is specific to a particular demographic, geographic location, type of content, billboard or any other factor.

In some cases, the player module 210 may retrieve and play digital content from the library as instructed by an advertiser 104, where no contract has been executed. In one embodiment, the player module 210 tracks, timestamps, and records each piece of digital content that is played, determines that the content is being played according to the terms of the contract, and sends data reports of the play times and content to the advertiser 104 or seller 106. The data may be sent in real time, or it may be sent periodically at specific times.

The player module 210 may create new playlists of digital content to be played on billboards 108 by evaluating an inventory of digital content. Prices for these playlists may remain constant or be changed. In one embodiment, the player module 210 may send digital content to mobile devices located within a particular radius of the billboard 108 currently playing the digital content.

The affiliate module 212 allows third-party affiliates to connect to the advertising platform 102. An affiliate may be assigned a unique identifier, which is used to present a web component or other identifier to the affiliate. This web component may be added to a website of the affiliate, in a chosen language or platform (e.g., MICROSOFT ASP.NET, RUBY, HTML, PHP, WORDPRESS, DRUPAL), or used manually by the affiliate. The web component may contain content from the advertising platform 102. This content may include a search box that advertisers 104 may use to search for an available billboard 108. Alternatively, the web component may display available billboards 108 and prices in a geographic region near an advertiser 104, or the advertiser 104 may select a particular geographic location to view the available billboards 108 in that location. When the advertiser 104 performs some action within the web component, the advertiser 104 may be directed to the advertising platform 102. The unique identifier may be assigned to the advertiser 104 using, for example, browser cookies, URL parameters, server-side sessions, or another tracking mechanism.

The affiliate module 212 may lower the cost for sellers 106 to sell billboard 108 space by allowing affiliates to connect to the advertising platform 102 and sell billboard 108 space. The effectiveness of using affiliates to attract advertisers 104 may be tracked by the affiliate module 212. For example, a seller 106 may implement a marketing initiative to attract affiliates and/or advertiser 104 to buy and sell billboard 108 space. The marketing initiative may include several campaigns, such as couponing, direct outbound telemarketing, billboard advertising, affiliate and referral sales, web and graphic designer affiliate network sales, part-time direct and freelance sales, media buyer and ad agency sales, web-site referrals, etc. The seller 106 can track the effectiveness of the marketing initiative periodically or in real-time, and mine data related to marketing initiative results.

After an advertiser 104 is directed to the advertising platform 102 by an affiliate's web component, the advertiser 104 may create a campaign and execute a contract to display digital content on a billboard 108. In this case, the affiliate may receive a portion of the contract payment or a fixed fee.

The accounting module 214 manages exchanges of funds for the digital content that is displayed on the billboards 108. In some embodiments, the accounting module 214 is controlled by a third party separate from the advertising platform 102. The accounting module 214 receives information regarding the contracts associated with advertisers 104, sellers 106, affiliates, and other parties for displaying digital content on billboards 108, and provides a contract invoicing and payment processing system for advertisers 104 to pay for their digital content displays. In an embodiment, advertisers 104 are charged according to the terms of the contract. In a further embodiment, all advertisers 104 with executed contracts associated with a particular billboard 108 may be charged by the lowest of the bids for a currently running campaign multiplied by the number of times their particular piece of digital content was flipped. The accounting module 214 can also provide a proof of performance report, which provides information regarding the date, the exact number of times and length of time that a particular piece of digital content was displayed on a billboard 108. In one embodiment, the proof of performance report includes photographs (such as a thumbnail image) or video (such as a time-lapse video) showing the display of the piece of digital content on the billboard 108.

To provide payment, advertisers 104, sellers 106, affiliates, and other parties may keep accounts on the advertising platform 102. Advertisers 104 can manually pay for their digital content from their accounts, or use a direct deposit to automatically use money from their accounts to pay for digital content. In another example, advertisers 104 can pay by sending a check or money order directly to the seller 106 or to the operator of the advertising platform 102. In one embodiment, buyers can use an automated payment module that provides electronic invoices and sends paper invoices. Sellers 106 can review proposals, contracts, advertiser metrics, and payment history using the accounting module. Sellers 106 may also change prices for digital content display depending on the digital content inventory and playlist. Furthermore, the accounting module can manage automated renewal notices for the digital content displays, and provide notifications to advertisers 104 with various digital content display opportunities.

When a media buyer has acted as an agent of the advertiser 104 in creating a campaign and executing a contract, the accounting module 214 may pay the media buyer accordingly. For example, the media buyer may be paid by a percentage of the contract, a fixed amount, or a transactional amount. The media buyer may be permitted to insert information into an invoice prepared by the accounting module 214, making the invoice compatible with a particular external accounting system (e.g., invoice number, SKU). The invoice may be sent in one of several file formats, including comma separated files or QUICKBOOK. The invoice may also include payment instructions for an advertiser 104 to pay the media buyer electronically.

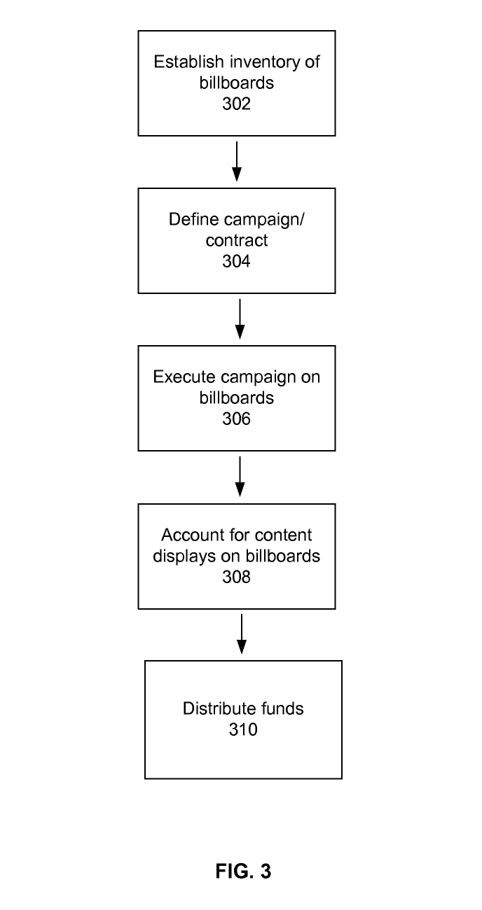

FIG. 3 is a flowchart illustrating steps performed by the advertising platform 102 to manage billboard advertising, according to one embodiment. Other embodiments of the advertising platform 102 may perform different or additional steps, and may perform the steps in different orders.

Initially, the advertising platform 102 establishes information 302 about an inventory of billboards 302. Billboards are operated by sellers, who provide the information regarding their billboards, including information about a geographic location of the billboard and available inventory of time intervals for displaying digital content. The advertising platform 102 then defines 304 a campaign, which includes defining pricing guidelines that indicate pricing requirements for the available inventory, and executing a contract. Either an advertiser 104, a seller 106, the advertising platform 102, or a combination of the three can define the terms of the campaign. Defining the campaign includes determining digital content that will be displayed, determining the billboards that will display digital content, determining the budget for the digital content display, and determining the time frame for the digital content display. In one embodiment, a module of the advertising platform 102 provides a template for the advertiser 104 to generate new digital content. Multiple advertisers 104 can bid for a campaign for a particular billboard, and the seller (or the system) can select one or more campaigns and associated contracts for execution.

After the specifics of a contract are approved by all parties involved, the associated campaign is executed 306 on the selected billboards based on a play schedule created for the campaign. Instructions are sent to the selected billboards for displaying the digital content associated with the campaign, and the digital content is displayed in accordance with the play schedule, which defines a time interval and number of times that the digital content associated with the campaign is displayed for the time interval. The advertising platform 102 keeps track of all transactions and the time frame of the digital content display on the billboards 108, and accounts 308 for any payment owed between the advertiser 104, seller 106, and operator of the advertising platform 102 regarding the billboard displays. Finally, funds are distributed to the appropriate parties 310 according to the accounting module. The funds may be taken from accounts that the advertiser 104 or seller 106 keep on the advertising platform 102, or payment can be collected by another method, for example, via third party electronic payment services or delivery of physical payment instruments.

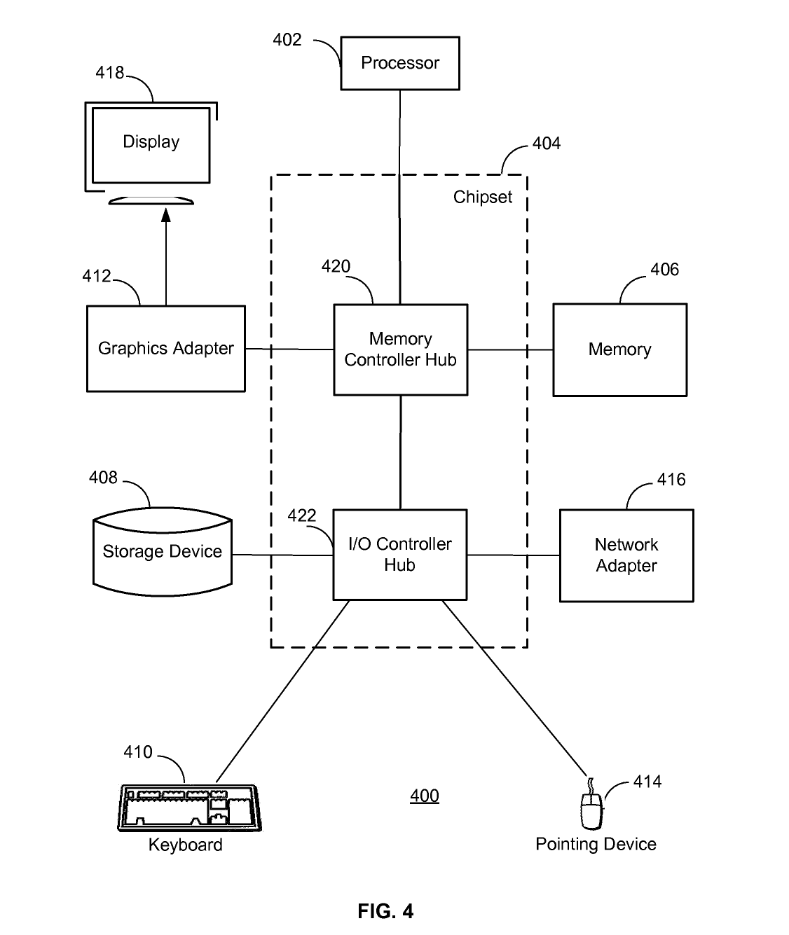

FIG. 4 is a high-level block diagram illustrating an example of a computing device, or computer 400, according to one embodiment. The computer 400 can be used by an advertiser 104, seller 106, or any other party to access the advertising platform 102 via the network 112. The computer 400 includes at least one processor 402 coupled to a chipset 404. The chipset 404 includes a memory controller hub 420 and an input/output (I/O) controller hub 422. A memory 406 and a graphics adapter 412 are coupled to the memory controller hub 420, and a display 418 is coupled to the graphics adapter 412. A storage device 408, keyboard 410, pointing device 414, and network adapter 416 are coupled to the I/O controller hub 422. Other embodiments of the computer 400 have different architectures.

The storage device 408 is a non-transitory computer-readable storage medium such as a hard drive, compact disk read-only memory (CD-ROM), DVD, or a solid-state memory device. The memory 406 holds instructions and data used by the processor 402. The pointing device 414 is a mouse, touch screen, or other type of pointing device, and is used in combination with the keyboard 410 to input data into the computer system 400. The graphics adapter 412 displays images and other information on the display 418. The network adapter 416 couples the computer system 400 to one or more computer networks.

The computer 400 is adapted to execute computer program modules for providing functionality described herein. Since “module” refers to computer program logic used to provide the specified functionality, a module can be implemented in hardware, firmware, and/or software. In one embodiment, program modules are stored on the storage device 408, loaded into the memory 406, and executed by the processor 402.

The types of computer 400 used in the environment 100 of FIG. 1 can vary depending upon the embodiment and the processing power required for the uses. The computers 400 can lack some of the components described above, such as keyboards 410, graphics adapters 412, and displays 418. As an example, an advertiser 104 or seller 106 may use a computing device comprising a mobile telephone with a touch screen but no physical keyboard.

The above description is included to illustrate the operation of the preferred embodiments and is not meant to limit the scope of the invention. The scope of the invention is to be limited only by the following claims. From the above discussion, many variations will be apparent to one skilled in the relevant art that would yet be encompassed by the spirit and scope of the invention.

1. A method for providing an advertising campaign on a digital billboard, comprising:
establishing information about at least one digital billboard operated by a seller, the established information comprising a geographic location of the digital billboard and an available inventory formed of time intervals in which digital content may be displayed by the digital billboard;
defining pricing guidelines for the seller, the pricing guidelines indicating pricing requirements for the available inventory on the digital billboard;
receiving a plurality of digital content campaigns from the plurality of advertisers, the digital content campaigns identifying the digital billboard operated by the seller and specifying pricing information indicating prices advertisers will pay to display digital content on the billboard;
selecting a digital content campaign of the plurality of digital content campaigns responsive to an analysis of the plurality of digital content campaigns and the pricing guidelines;
creating a play schedule for the selected digital content campaign, the play schedule defining a time interval and a number of times that digital content associated with the selected digital content campaign will be displayed on the digital billboard for the time interval; and
providing instructions to the digital billboard for displaying the digital content associated with the selected digital content campaign according to the play schedule.

2. The method of claim 1, further comprising receiving in the digital content campaign a selection of a frequency for displaying digital content on the digital billboard, wherein the play schedule is created based on the received frequency selection.

3. The method of claim 1, wherein the pricing guidelines are defined based on a fixed frequency for displaying digital content on the digital billboard, wherein the play schedule is created based on the fixed frequency.

4. The method of claim 1, wherein the established information about the at least one digital billboard further comprises information about at least one of: traffic conditions near the digital billboard, proximity of the digital billboard to a specific business, and proximity of the digital billboard to a selected geographic region.

5. The method of claim 1, further comprising receiving in a digital content campaign instructions to display digital content on the digital billboard on specified days of a week or specified times during a day, wherein the play schedule is created based on the received instructions.

6. The method of claim 1, wherein the pricing requirements comprise a fixed price, and wherein the pricing information is specified based on the fixed price.

7. The method of claim 1, wherein the pricing requirements comprise a bidding scheme specifying a budget and a time frame, and wherein the pricing information is specified based on the bidding scheme.

8. The method of claim 1, further comprising:
selecting a second digital content campaign of the plurality of digital content campaigns;
creating a play schedule for the selected second digital content campaign, the play schedule distinct from the play schedule created for the selected digital content campaign; and
providing instructions to the digital billboard for displaying the digital content associated with the selected second digital content campaign according to the play schedule for the selected second digital content campaign, wherein the digital billboard is configured to combine the play schedule created for the selected digital content campaign with the play schedule for the selected second digital content campaign.

9. The method of claim 1, further comprising:
receiving digital content associated with the selected digital content campaign;
modifying the digital content, the modifying comprising changing a graphic element of the digital content; and
including the modified digital content in the selected digital content campaign.

10. The method of claim 1, further comprising:
assessing the digital content associated with the selected digital content campaign, the assessment confirming whether the digital content associated with the selected digital content campaign fulfills content restrictions; and
responsive to confirming that the digital content associated with the selected digital content campaign does not fulfill the content restrictions, rejecting the selected digital content campaign.

11. The method of claim 1, further comprising formatting the digital content associated with the selected digital content campaign, wherein the formatting allows the digital content associated with the selected digital content campaign to be displayed according to dimensions of the digital billboard.

12. The method of claim 1, wherein the provided instructions to the digital billboard comprise a file containing the digital content associated with the selected digital content campaign, wherein the file comprises executable code.

13. A non-transitory computer-readable storage medium storing instructions, the instructions when executed by a processor causing the processor to:
establish information about at least one digital billboard operated by a seller, the established information comprising a geographic location of the digital billboard and an available inventory formed of time intervals in which digital content may be displayed by the digital billboard;
define pricing guidelines for the seller, the pricing guidelines indicating pricing requirements for the available inventory on the digital billboard;
receive a plurality of digital content campaigns from the plurality of advertisers, the digital content campaigns identifying the digital billboard operated by the seller and specifying pricing information indicating prices advertisers will pay to display digital content on the billboard;
select a digital content campaign of the plurality of digital content campaigns responsive to an analysis of the plurality of digital content campaigns and the pricing guidelines;
create a play schedule for the selected digital content campaign, the play schedule defining a time interval and a number of times that digital content associated with the selected digital content campaign will be displayed on the digital billboard for the time interval; and
provide instructions to the digital billboard for displaying the digital content associated with the selected digital content campaign according to the play schedule.

14. The non-transitory computer-readable storage medium of claim 13, wherein the processor is further caused to receive in a digital content campaign a selection of a frequency for displaying digital content on the digital billboard, wherein the play schedule is created based on the received frequency selection.

15. The non-transitory computer-readable storage medium of claim 13, wherein the pricing guidelines are defined based on a fixed frequency for displaying digital content on the digital billboard, wherein the play schedule is created based on the fixed frequency.

16. The non-transitory computer-readable storage medium of claim 13, wherein the established information about the at least one digital billboard further comprises information about at least one of: traffic conditions near the digital billboard, proximity of the digital billboard to a specific business, and proximity of the digital billboard to a selected geographic region.

17. The non-transitory computer-readable storage medium of claim 13, wherein the processor is further caused to receive in a digital content campaign instructions to display digital content on the digital billboard on specified days of a week or specified times during a day, wherein the play schedule is created based on the received instructions.

18. The non-transitory computer-readable storage medium of claim 13, wherein the pricing requirements comprise a fixed price, and wherein the pricing information is specified based on the fixed price.

19. The non-transitory computer-readable storage medium of claim 13, wherein the pricing requirements comprise a bidding scheme specifying a budget and a time frame, and wherein the pricing information is specified based on the bidding scheme.

20. A computer system comprising:
a processor; and
a memory storing instructions executable by the processor to:
establish information about at least one digital billboard operated by a seller, the established information comprising a geographic location of the digital billboard and an available inventory formed of time intervals in which digital content may be displayed by the digital billboard;
define pricing guidelines for the seller, the pricing guidelines indicating pricing requirements for the available inventory on the digital billboard;
receive a plurality of digital content campaigns from the plurality of advertisers, the digital content campaigns identifying the digital billboard operated by the seller and specifying pricing information indicating prices advertisers will pay to display digital content on the billboard;
select a digital content campaign of the plurality of digital content campaigns responsive to an analysis of the plurality of digital content campaigns and the pricing guidelines;
create a play schedule for the selected digital content campaign, the play schedule defining a time interval and a number of times that digital content associated with the selected digital content campaign will be displayed on the digital billboard for the time interval; and
provide instructions to the digital billboard for displaying the digital content associated with the selected digital content campaign according to the play schedule.
